(19) United States
(12) Patent Application Publication
(10) Pub. No.: US 2018/0297234 A1
(43) Pub. Date: Oct. 18, 2018

(54) METHOD FOR PRODUCING CONCRETE PIPES

(71) Applicant: Ulrich Schlüsselbauer, Altenhof am Hausruck (AT)

(72) Inventor: Ulrich Schlüsselbauer, Altenhof am Hausruck (AT)

(21) Appl. No.: 15/765,444

(22) PCT Filed: Oct. 13, 2016
(86) PCT No.: PCT/AT2016/050260

§ 371 Date: Apr. 2, 2018

(30) Foreign Application Priority Data
Oct. 16, 2015 (AT) A50881/2015

(51) Int. Cl. B28B 21/76; B28B 21/10; B28B 21/90

(52) U.S. Cl. CPC B28B 21/765; B28B 21/90; B28B 21/10

(57) ABSTRACT

A method for producing concrete pipes in a vertical casting mould comprising a moulding space (4) between a core (2) and a mantle (3) divided lengthwise and comprising mould sleeves (5, 9) which terminate the moulding space (4) at the bottom and at the top is described, wherein pourable concrete is poured into the moulding space (4) and the pipe body (7) is demoulded after setting of the concrete by opening the mantle (3). In order to be able to cast high-quality concrete pipes, it is proposed that the pourable concrete is poured into the moulding space (4) in a predetermined quantity when the upper mould sleeve (9) is removed and that the upper mould sleeve (9) forming a closed ring is pressed in a shaping manner into the end face of the pipe body (7) only after a setting time for a predefined setting volume of the cast pipe body (7) between the core (2) and the mantle (3).

### FIELD OF THE INVENTION

The invention relates to a method for producing concrete pipes in a vertical casting mould comprising a moulding space between a core and a mantle divided lengthwise and comprising mould sleeves which terminate the moulding space at the bottom and at the top, wherein pourable concrete is poured into the moulding space and the pipe body is demoulded after setting of the concrete by opening the mantle.

### DESCRIPTION OF THE PRIOR ART

In contrast to a shaking pressing process, in a wet concrete casting method pourable concrete is poured into the moulding space of a casting mould, which has the result that the concrete body in the casting mould must set before it can be demoulded. For the production of concrete pipes in vertical casting moulds this means that for demoulding the set concrete body, the divided mantle of the casting mould is either opened by expanding or radially pulling apart the mantle halves and the core is reduced in its diameter. Since the upper mould sleeve is assigned to the mantle, the upper mould sleeve must also be divided. However, the upper mould sleeve must allow a pouring of the pourable concrete into the moulding space from above which requires upper mould sleeves which are open on the front side, with the disadvantage that the end faces of the pipe body in the region of the open front sides of the upper mould sleeves must be smoothed by hand, and what is more, the setting behaviour of the pourable concrete poured into the moulding space can scarcely be taken into account. In the course of the setting process the air bubbles included in the pourable concrete escape upwards and can only partially escape via the open front side of the upper mould sleeve so that the air bubbles collecting in particular in the region of the outer circumferential wall of the upper mould sleeve cause undesired air pores in the region of the recessed front-side coupling attachments of the finished concrete pipes.

In order to be able to take into account the setting behaviour of concrete pipes produced by the shaking pressing method after demoulding, it is known (EP 0 476 245 A2) to press the upper mould sleeve in a shaping manner onto the compacted concrete body only after a compaction of the concrete caused by a shaking whilst displacing the excess concrete from the moulding space between mould core and mould mantle so that a uniformly compacted concrete body can be assumed even in the region of the coupling attachment formed by the upper mould sleeve. Apart from the fact that in a shaking pressing method, unlike a wet concrete casting method the difficulties caused by air bubbles ascending in the pourable concrete do not occur, in this known shaping pressing method to produce pipe bodies, the escape of the excess concrete from the moulding space should be seen as disadvantageous. In addition, a relative movement between the mould core and the mould mantle is required to be able to close the annular opening between the upper mould sleeve and the core, which annular opening is required to displace the excess concrete from the moulding space.

### SUMMARY OF THE INVENTION

It is therefore the object of the invention to configure a wet concrete casting method to produce concrete pipes in the moulding space between a core and a mantle of a vertical casting mould so that not only the requirements for a true-to-size formation of the coupling attachments formed by the upper moulding sleeve are created but also the risk of the formation of air pores in the set concrete pipe can be avoided and the setting behaviour of the pourable concrete can be taken into account in a simple manner.

Starting from a method of the type described initially, the invention solves the formulated object in that the pourable concrete is poured into the moulding space in a predetermined quantity when the upper mould sleeve is removed and that the upper mould sleeve forming a closed ring is pressed in a shaping manner into the end face of the pipe body only after a setting time for a predefined setting volume of the cast pipe body between the core and the mantle.

Since the pourable concrete is cast in the moulding space when the upper mould sleeve is removed and the upper mould sleeve is pressed into the still pourable concrete only after a predefined setting time, the air bubbles ascending in the pipe body during the setting time can escape upwards unhindered through the upper mould sleeve, so that during the subsequent compression moulding of the front-side coupling attachment by pressing the upper mould sleeve into the still pourable concrete smooth wall surfaces can be formed not only in the circumferential region but also in the region of the front side. The waiting for the setting process for the concrete cast in the moulding space and the subsequent forming of the coupling attachment however requires a filling of the moulding space with a predefined quantity of pourable concrete in order to be able to ensure a predefined length of the concrete pipe to be produced. Accordingly a filling volume must be provided which exceeds the volume of the concrete pipe to be produced by the setting volume. The setting behaviour of different concrete compositions and therefore the respective setting volume to be taken into account can be determined simply for example by experiments. In practice, it has been found that even after a few minutes a setting is present which allows a compression moulding by the upper mould sleeve within a predefined manufacturing tolerance.

The compression moulding of the front-side coupling attachment of the concrete pipe to be produced can be assisted by turning the upper mould sleeve during and/or after the pressing into the pourable concrete.

### BRIEF DESCRIPTION OF THE DRAWING

The method according to the invention is explained in detail with reference to the drawings. In the figures:

FIG. 1 shows a casting mould for carrying out a method of production according to the invention for concrete pipes in an axial section with an upper mould sleeve raised from the moulding space directly after filling with pourable concrete,

FIG. 2 shows the moulding space between core and mantle of the casting mould in sections in the region of the upper mould sleeve after the setting process of the pipe body made of pourable concrete in a larger scale and

FIG. 3 shows a view corresponding to FIG. 2 of the casting mould after the shaping pressing of the upper mould sleeve into the pipe body.

### DESCRIPTION OF THE PREFERRED EMBODIMENT

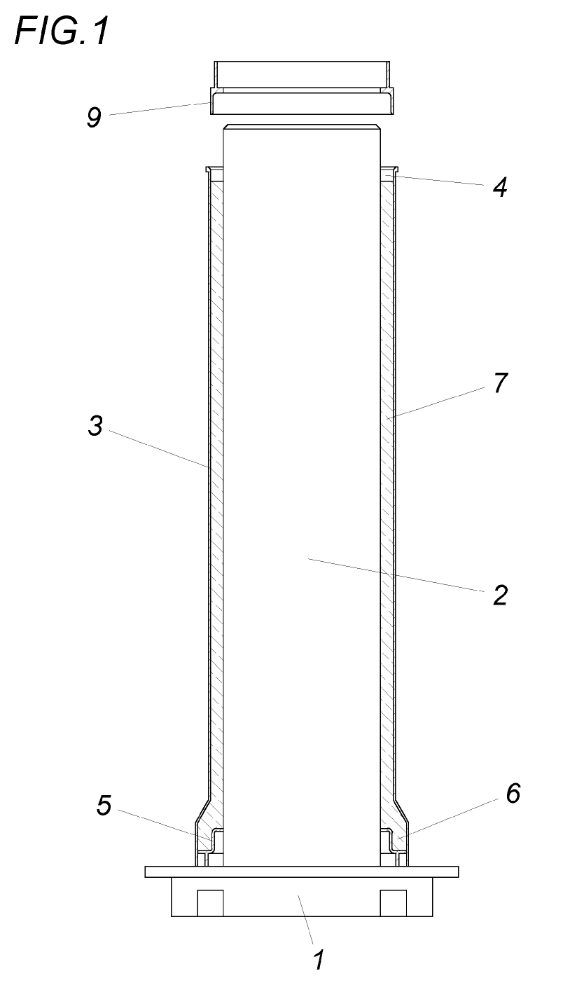

As can be deduced in particular from FIG. 1, a casting mould for carrying out the wet concrete casting method according to the invention to produce a concrete pipe has a base 1 with a core 2 and a mantle 3 between which and the core 2 an annular moulding space 4 is formed. At the bottom this moulding space 4 is terminated by a mould sleeve 5 which rests on the base 1 and combined with the mantle 3 provides for the formation of an extended sleeve 6 at the lower end of the pipe body 7 made of concrete. A separate upper mould sleeve 9 in the form of a closed ring which is inserted coaxially to the casting mould between the core 2 and the mantle 3 under pressure into the annular space 4 and preferably can be rotated about its axis is used to form a recessed coupling attachment 8 which is complementary to the sleeve 6, and which can be seen from FIG. 3 at the opposite end of the pipe body 7.

For demoulding a concrete pipe which has been produced, usually both the core 2 and also the mantle 3 are divided lengthwise. Whilst the mantle 3 must be withdrawn radially outwards from the concrete pipe to be demoulded, the core is to be drawn radially inwards to release the pipe body 7. This is achieved in a manner known per se whereby the longitudinal edges of the divided circumferential wall of the core 2 which run parallel to one another at a distance in the circumferential direction in the usage position of the core are pulled towards one another. In the case of a conical core configuration, a division of the core which is otherwise required can also be omitted. The longitudinal edges of the divided mantle 3 which abut against one another in the usage position of the mantle 3 are accordingly pulled apart. In the case of a one-piece design, the mantle 3 is thus widened whilst in the case of a two-part design the two mantle halves are pulled apart.

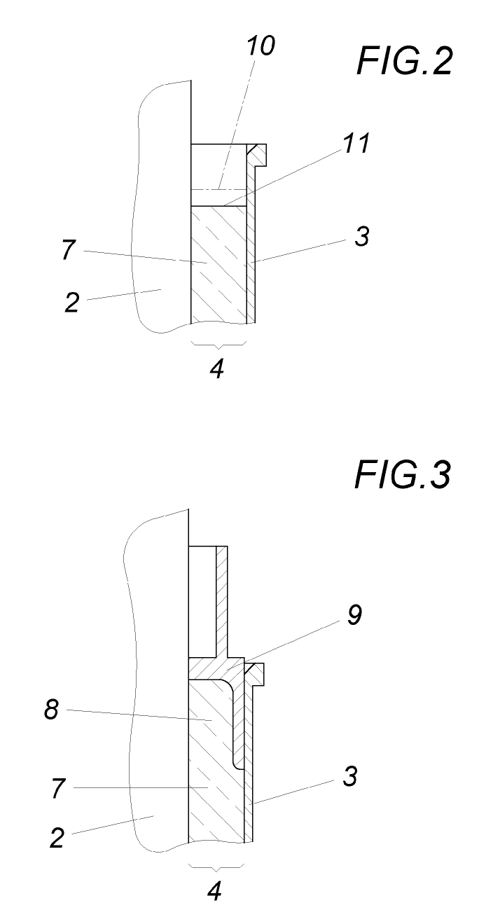

In order to produce a concrete pipe, pourable concrete is poured in a predefined quantity matched to the pipe to be produced into the moulding space 4 between the core 2 and the mantle of the casting mould when the upper mould sleeve 9 is raised usually from above according to FIG. 1. In special cases however a pressing of the pourable concrete through a mantle opening into the moulding space 4 is possible. Before the upper mould sleeve 9 is pressed into the pipe body 7 onto pourable concrete to form a coupling attachment 8, a setting of the pipe body 7 is awaited. During this setting time the filling level of the moulding space 4 according to FIG. 2 drops from an initial level 10 indicated by a dot-dash line to a level 11 accompanied by compaction of the concrete. In order to shorten the setting time, the mantle and/or the core can be provided with a shaking drive.

The air bubbles enclosed in the pourable concrete can escape upwards from the moulding space 4 during this setting time so that during the subsequent pressing of the upper mould sleeve into the pourable concrete between the core 2 and the mantle 3 the coupling attachment 8 is formed free from pores with smooth wall surfaces. Care should merely be taken to ensure that the air collecting above the pipe body 7 during insertion of the upper mould sleeve 9 into the moulding space 4 can escape from the mould sleeve 9 which is ensured by the necessary guide gap between the upper mould sleeve 9 and the core 2.

After a setting of the concrete necessary for demoulding, the pipe body 7 can be demoulded by opening the mantle 3 and pulling it apart radially outwards and pulling the core 2 radially in. The upper mould sleeve 9 can remain on the pipe body 7 during the demoulding but can also be removed beforehand.

1. A method for producing concrete pipes in a vertical casting mould, said method comprising:
providing a core and a mantle that is divided lengthwise, said core and mantle defining a moulding space therebetween, and mould sleeves that terminate the moulding space at a bottom and a top thereof;
pouring pourable concrete into the moulding space so as to form a pipe body;
demoulding the pipe body after setting of the concrete by opening the mantle; and
wherein the pourable concrete is poured into the moulding space in a predetermined quantity with the upper mould sleeve is removed; and
pressing the upper mould sleeve forming a closed ring in a shaping manner into an end face of the pipe body only after a setting time for a predefined setting volume of the cast pipe body between the core and the mantle.

2. The method according to claim 1, wherein the upper mould sleeve is pressed into the pipe body between the core and the mantle and turned about an axis thereof.

3. A method for producing concrete pipes in a vertical casting mould, said method comprising:
providing a core surrounded by a mantle, said mantle being divided lengthwise thereof, said core and mantle defining a moulding space therebetween, and said mantle having mould sleeves that define top and bottom terminal ends of the moulding space, the upper mould sleeve forming a closed ring;
pouring a predetermined quantity of pourable concrete into the moulding space with the upper mould sleeve removed so as to form a pipe body;
after a setting time for a predefined setting volume of a cast pipe body formed between the core and the mantle is elapsed after said pouring, shaping an end face of the cast pipe body by pressing the upper mould sleeve into the end face of the cast pipe body; and
demoulding the pipe body after setting of the concrete by opening the mantle.

4. The method according to claim 3, wherein the upper mould sleeve is pressed into the pipe body between the core and the mantle and turned about an axis thereof.
